(19) United States
(12) Patent Application Publication
(10) Pub. No.: US 2015/0308819 A1
(43) Pub. Date: Oct. 29, 2015

(54) TREE LEVELING DEVICE AND ASSOCIATED METHODS

(71) Applicant: Shining Sea Trading Company, West Valley City, UT (US)

(72) Inventor: Jared Hendricks, Draper, UT (US)

(21) Appl. No.: 14/662,104

(22) Filed: Mar. 18, 2015

Related U.S. Application Data
(60) Provisional application No. 61/955,088, filed on Mar. 18, 2014.

(51) Int. Cl. G01C 9/26

(52) U.S. Cl. CPC G01C 9/26

(57) ABSTRACT

Devices and methods for positioning objects in a desired position are provided. In one example, a leveling device for positioning an artificial tree in a vertical position can include a housing, an elongate section extending from the housing and having a structure operable to be inserted into an end of a trunk segment of an artificial tree, and a level indicator coupled to the housing and positioned to facilitate viewing by a user for leveling the trunk segment in a vertical position.

### PRIORITY DATA

This claims the benefit of U.S. Provisional Patent Application Ser. No. 61/955,088, filed on Mar. 18, 2014, which is incorporated herein by reference in its entirety.

### BACKGROUND

The leveling of various objects can be important for structural integrity and/or aesthetic design. The process of leveling is generally the use of a level to allow an object to be aligned to a certain angle or range of angles, in many cases irrespective of the underlying support or support structure upon which the object is mounted. A carpenter's level, for example, can be used to align a wall to a vertical orientation during building of a house. Such vertical orienting can be accomplished irrespective of the angle or condition of the floor. This is mainly due to the fact that the level is using a leveling bubble that functions as a result of hydrostatic pressure on the bubble, which is not associated with the floor.

### BRIEF DESCRIPTION OF THE DRAWINGS

For a fuller understanding of the nature and advantage of the present invention, reference is being made to the following detailed description of preferred embodiments and in connection with the accompanying drawings, in which:

FIG. 1 is a schematic diagram of a leveling device in accordance with one aspect of the present disclosure;

FIG. 2 is a schematic diagram of a leveling device in accordance with another aspect of the present disclosure;

FIG. 3 is a schematic diagram of a leveling device in accordance with another aspect of the present disclosure;

FIG. 4 is a schematic diagram of a leveling device in accordance with another aspect of the present disclosure;

FIG. 5 is a schematic diagram of a close up view of a section of a leveling device in accordance with another aspect of the present disclosure;

FIG. 6 is a schematic diagram of a leveling device in accordance with another aspect of the present disclosure;

FIG. 7 is a schematic diagram of a leveling device in accordance with another aspect of the present disclosure;

FIG. 8A is a schematic diagram of a leveling device in accordance with another aspect of the present disclosure;

FIG. 8B is a schematic diagram of a leveling device in accordance with another aspect of the present disclosure; and

FIG. 9 is a diagram of a method for positioning an artificial tree in a vertical position device in accordance with another aspect of the present disclosure.

### DETAILED DESCRIPTION

Before the present disclosure is described herein, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

### DEFINITIONS

The following terminology will be used in accordance with the definitions set forth below.

It should be noted that, as used in this specification and the appended claims, the singular forms “a,” and, “the” include plural referents unless the context clearly dictates otherwise. Thus, for example, reference to “a level” includes one or more of such levels and reference to “the segment” includes reference to one or more of such segments.

In this application, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the composition's nature or characteristics would be permissible if present under the “consisting essentially of” language, even though not expressly recited in a list of items following such terminology. When using an open ended term, like “comprising” or “including,” it is understood that direct support should be afforded also to “consisting essentially of” language as well as “consisting of” language as if stated explicitly, and vice versa. Further, it is to be understood that the listing of components, species, or the like in a group is done for the sake of convenience and that such groups should be interpreted not only in their entirety, but also as though each individual member of the group has been articulated separately and individually without the other members of the group unless the context dictates otherwise. This is true of groups contained both in the specification and claims of this application. Additionally, no individual member of a group should be construed as a de facto equivalent of any other member of the same group solely based on their presentation in a common group without indications to the contrary.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint.

As used herein, the term “vertical position” refers to an orientation of an object that visually appears to be vertical with respect to an observer, whether by visual inspection of the object or by visual inspect of a level indicator associated with the object. Thus while the object may be oriented to a true vertical position, “vertical” includes positions that are subjectively vertical to the observer.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually.

This same principle applies to ranges reciting only one numerical value as a minimum or a maximum. Furthermore, such an interpretation should apply regardless of the breadth of the range or the characteristics being described.

The Disclosure

The present disclosure relates to devices for leveling a various objects, including various associated methods. In one aspect, such devices can be used to level a tree, including both natural and artificial trees. In particular, decorative trees can be more aesthetically pleasing when properly leveled. Decorative trees are used in many locals and on many occasions, and can include holiday trees as well as trees intended for non-holiday occasions and for long term or even year-round display. One specific example of a holiday a tree is a Christmas tree. With respect to trees, it is noted that the present disclosure is not limited to holiday trees or any specific type of tree, but rather the present scope extends to any type of tree that is capable of being leveled. As one example, the present devices and methods can be used to level trees as they are planted. More broadly, the present devices and methods can be utilized to level other objects, horizontally, vertically, or at any angle therebetween, as will be discussed more fully below. It is therefore noted that, while the present disclosure describes primarily natural and artificial tree leveling, the breadth of the present scope should not be limited to trees and tree leveling.

In one aspect, a leveling device can be useful for leveling a vertically oriented tube, pipe, cylinder, post, or other similar structure. The design of the leveling device can thus vary depending on the nature of the structure being leveled, and the intended manner in which the leveling device is to be coupled to that structure. One example includes an artificial tree having sectional segments. Such segments can be referred to as “trunk segments,” which generally form a structural backbone for an artificial tree from which the branches of the artificial tree generally extend. Trunk segments can be hollow tubes or pipes, solid cylindrical or other shape material, and the like. As a general matter, trunk segments are often hollow and have an open end to conserve on material costs and lighten the overall weight of the tree. The leveling devises described are thus generally directed to this hollow tube/open end design, however modifications in leveling device design are contemplated to account for trunk segments that are solid or that lack an open end.

Thus in one example a leveling device for positioning an artificial tree in a vertical position can include a housing having an elongate section extending from the housing. The elongate section can have a structure that is operable to be inserted into an end of a trunk segment of the artificial tree. The device can also include a level indicator coupled to the housing and positioned to facilitate viewing by a user for leveling the trunk segment in a vertical position. For trees with multiple trunk segments having open ends, each trunk segment can be sequentially aligned in a vertical position upon insertion into the previously leveled trunk segment, thus maintaining the vertical alignment along the entire length of the tree. More specifically, a leveling device is inserted into a trunk segment, and the trunk segment is leveled to a vertical position by a user viewing a level indicator coupled to the leveling device. Once a vertically-leveled position is determined, the leveling device is removed. The next trunk segment is then be inserted into the previously-aligned trunk segment, and the process is repeated. In some cases a trunk segment can be fixed in place following leveling to maintain the vertical alignment. In the case of an artificial holiday tree, for example, in the bottommost trunk segment and/or the tree stand can be leveled. In another example subsequent trunk segments of the artificial tree can be leveled in a similar manner. In examples of trees having a single trunk segment, leveling can be accomplished by leveling the coupling portion of the tree stand, by leveling the single trunk segment using an alternative leveling device design that couples, for example, along the side of the trunk segment, or by leveling via by both techniques.

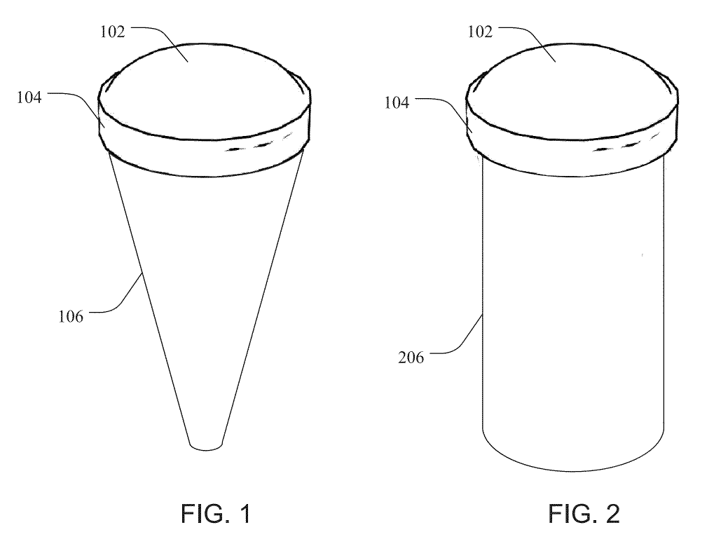

One exemplary leveling device is shown in FIG. 1. The leveling device includes a leveling indicator 102 positioned in a housing 104. An elongate section 106 extends from the housing 104, which has a structure that allows insertion into an open end of a trunk segment (not shown). FIG. 1 shows a design in which the elongate section 106 has a cone shape. A cone-shaped elongate section 106 allows the insertion of the leveling device into trunk segments having various sizes of inside diameter openings. Thus the cone can be inserted into an opening to a point where the cone has a sufficient diameter to contact the inside of the trunk segment structure. The leveling device will thus insert into trunk segments to a greater or lesser extent depending on the inside diameter of a given segment.

FIG. 2 shows a non-limiting example of a similar design having an elongate section 206 having a cylindrical design. In such cases, the elongate section can be sized to allow insertion into a given trunk segment inside diameter. In some examples the elongate section 206 can be designed to match a given trunk segment and thus allow a snug fit or a fit that has simultaneous frictional contact on opposite sides of the elongate section. In other examples the elongate section 206 can be designed to have an outside diameter that is merely smaller than the inside diameter of the trunk segment, regardless of the tightness of the fit. For both the cone and cylindrical designs, the greater the contact between the elongate section and the inside of the trunk segment, the greater the influence of the elongate section on the positioning of the leveling device. For elongate sections having an inside diameter that is large enough to not create such a snug fit, the underside of the housing 104 will likely contact and rest on the end of the trunk segment. It is additionally contemplated that one or more stop structures can be coupled to the housing to prevent the leveling device from falling into the interior of the trunk segment.

Additionally, the elongate section can include other structural designs. In some cases the elongate section can be designed to accommodate or account for a particular trunk segment design. In other cases, the design of the elongate section, as well as the design of the leveling device, can vary depending on aesthetics, specific functionality, materials used, manufacturing costs, and the like. As one example, the elongate section can have a substantially uniform cross section along at least 90% of its length. In another example, the elongate section can have a substantially uniform cross section along at least 25% of its length. In another example, the elongate section can have a non-uniform cross section along at least 90% of its length. In yet another example, the elongate section can be tapered along at least 90% of its length. It is noted that, “substantially uniform” is intended to describe a structure that would appear to be uniform to an observer, such as one of ordinary skill in the art, and is not intended to require that the structure be measured to a uniform standard, although such a strictly uniform structure would be included within this definition.

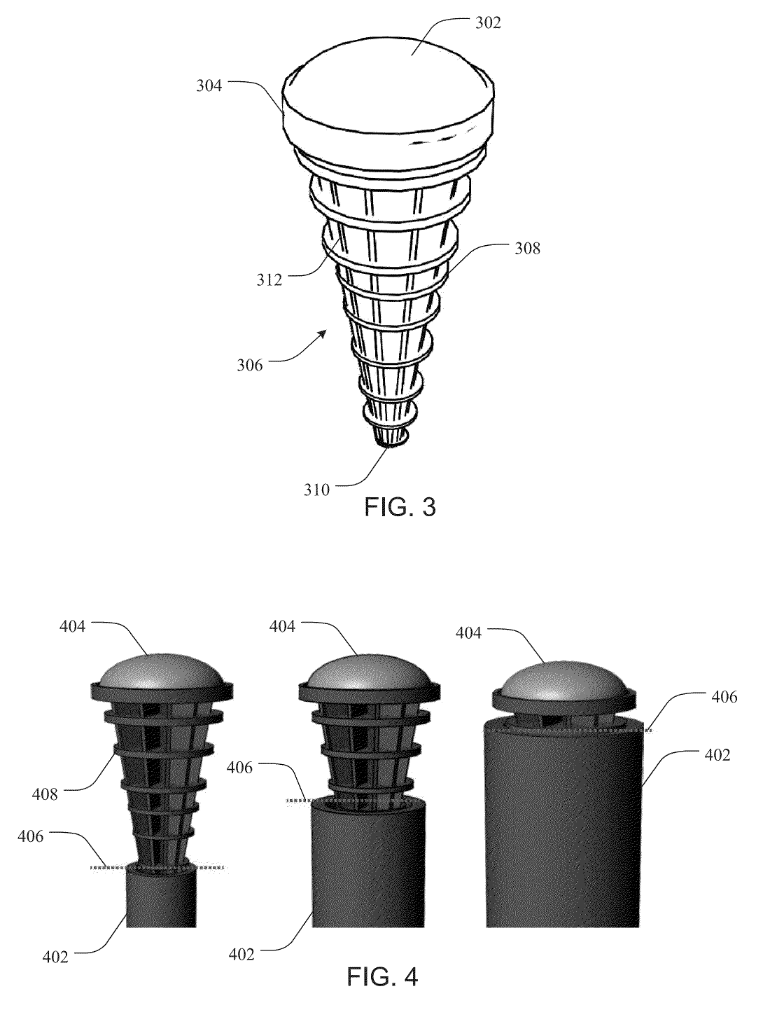

In another example, as is shown in FIG. 3, a leveling device can include a leveling indicator 302, a housing 304, and an elongate section 306. In this case, the elongate section 306 can include a plurality of concentric disks 308 or disk-like structures coupled together along a central core 310. The concentric disks can be arranged in any useful configuration, and can be uniformly spaced or non-uniformly spaced. In some cases the concentric disks can be oriented parallel to a leveling plane of the level indicator, or in other words, oriented such that the planes of the disks are oriented parallel with the leveling plane. The leveling plane is defined as the plane upon which the leveling indicator is intended to function.

In some cases the elongate section 306 can include axial structures 312 running generally along the central core, or even making up the central core. It is contemplated that device designs can include concentric disks with no axial structures, axial structures with no concentric disks, and devices having both concentric disks and axial structures. The axial structures can extend to a central axis of the elongate structure, or only part of the way to the central axis, and can contact the central core or stop a distance from the central core. In some cases, the axial structures contact one another at the central axis, and thus form the central core. FIG. 3 shows the concentric disks 308 and the axial structures 312 forming a general cone-like shape. Other shapes are contemplated, and a cone has been used for illustration purposes. Additionally, the overall shape of the elongate structure 306 that contacts the trunk segment can be formed by concentric disks, the axial structures, both the concentric disks and the axial structures, or an addition structure associated therewith.

It is noted that the disks and axial structures, either alone or in combination, can serve a variety of non-limiting functions, including providing structural integrity to the device using less material, reducing the weight of the device, allowing increased tactile control, and the like. Additionally, these structures can be utilized to orient the leveling device within the trunk segment, including segments of different inside diameter sizes.

Turning to FIG. 4, for example, a series of trunk segments 402 of different sizes to be leveled is shown for illustration. In each case, the leveling device 404 is inserted into the trunk segment 402 into a snug position. As can be seen from the figure, the leveling device 404 can be inserted into each trunk segment 402 to a point at which the inside diameter of the trunk segment 402 is roughly equal to the outside circumference of a point on the cone of the leveling device 404, as can be seen at the reference line 406. At this point, the disks 408 can be used as a guide to approximate a properly oriented position of the leveling device 404 within the trunk segment 402 by comparing visually the alignment of a nearby disk with the top edge of the trunk segment. Once the leveling device is in a proper position, the tree or other object can be leveled by moving the tube and viewing the level indicator until a desired position is indicated.

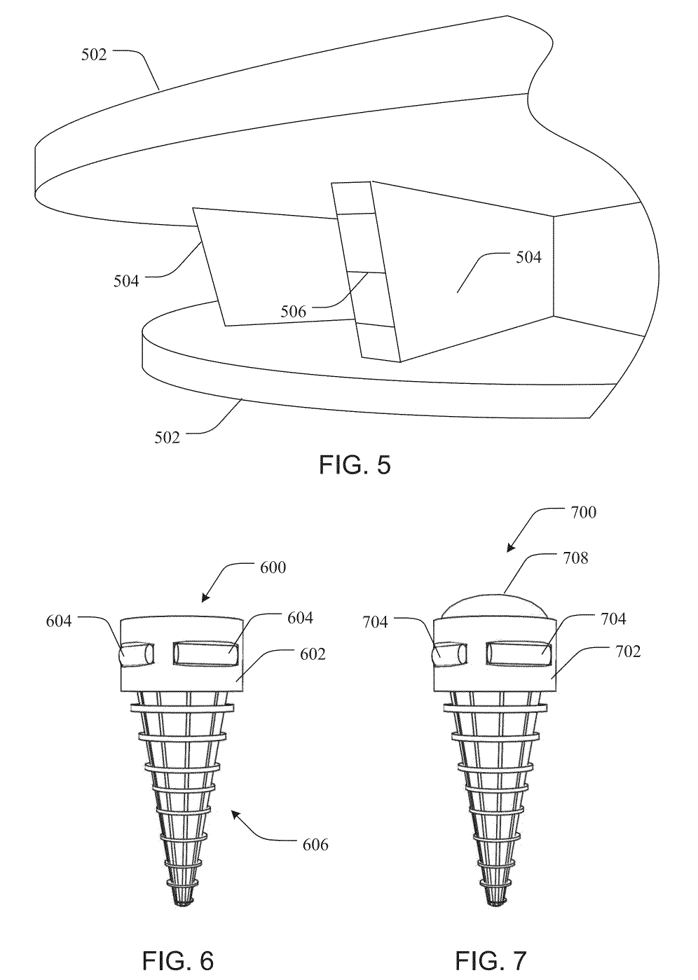

It is additionally contemplated that the axial structures can be utilized as a guide to approximate a properly oriented position of the leveling device within the trunk segment. The use of the axial structures as a guide can be used in conjunction with the above described disk structures to approximate the position, or either structure can be used independently of the other. FIG. 5 shows a section of the cone-shaped leveling device, including disk structures 502 and axial structures 504. In this case, one or more axial structures can include incremental markings 506 to allow a visual alignment of the leveling device with the trunk segment at finer increments as compared to the disk structures 502. As such, the leveling device is inserted into a trunk segment, and the nearest incremental marking 506 is noted. By comparing to incremental markings on other axial structures around the device, a proper positioning of the device with respect to the trunk segment can be achieved. Once the leveling device is in a proper position, the tree or other object can be leveled by moving the trunk segment and viewing the level indicator until a desired position is indicated. It is additionally noted that indicator markings can be utilized in any design of device, and should not be limited to the examples shown in FIGS. 4 and 5.

In general, the housing of devices according to the present disclosure can be made of any useful material capable of securing the leveling indicator and, in some cases, being coupled to the object to be leveled. Non-limiting examples include polymeric materials, including various plastic polymers, natural and synthetic rubbers, wood, metals and metal alloys, glass, ceramics, and the like. The elongate section can be formed of the same material as the housing, or the elongate section can be formed from similar or even a disparate material from the housing. In one example the housing and the elongate section can be made from the same material, either formed as the same structure or formed separately and subsequently assembled together. In one example, the housing can be formed having a core or shaft extending therefrom, or having such a core or shaft attached thereto. A coating material can be applied around the core to thus form the elongated section from a combination of the core and the coating material. In this manner, an elongate section can be formed having various beneficial properties that may be difficult to achieve using only a single material. For example, the core of the housing can provide a stiff structure, and a more flexible coating material (e.g., soft rubber, soft polymers, etc.) can provide a structure that can more effectively grip the inside of the trunk segment as compared to a stiffer material used in the core or the housing. Materials suitable for manufacturing such devices, as well as appropriate manufacturing techniques, are well known in the art, including non-limiting examples such as injection molding, extrusion, 3D printing, sintering, and the like.

The leveling indicator can be any known indicator, such as, for example, a bubble level, a digital level, a pendulum level, laser level, and the like, including appropriate combinations thereof. In one specific example, the leveling indicator can be a bubble level. Additionally, a device can include multiple leveling indicators, which can include the same or different types of indicators. A leveling indicator can be positioned at any useful location on the device that allows the indicator to be utilized. In one example, a level indicator is positioned in the housing on a central axis of the elongate section. FIG. 3 shows one example of such an arrangement. Additionally, as is shown in FIG. 6, one design of a leveling device 600 includes one or more leveling indicators 604 positioned in the housing 602 offset from the central axis of the elongate section 606, in this case on a side location of the housing 602. As a specific example, one or more horizontal bubble levels can be coupled to one or more side locations of the housing of the leveling device. In this manner, a tree or other object can be leveled by moving the trunk segment and viewing the level indicator from the side until a desired position is indicated. Offset leveling indicators are also contemplated at least along the top surface of the housing. Additionally, as is shown in FIG. 7, it is contemplated that a leveling device 700 can include one or more leveling indicators 704 on one or more side locations of the housing 702 for side viewing and positioning, and at least one leveling indicator 708 coupled to a top portion of the leveling device for viewing and positioning from above.

In other examples, leveling devices are contemplated that differ to varying degrees from the insertion-type devices described above. For example, it is additionally contemplated that a leveling device can have a housing coupled to one or more leveling devices, where the housing couples or is coupled to the outside of a pipe, tube, trunk segment, or other object to be leveled. In one aspect such a device can include a housing that couples to an outside surface of an end portion of the device. Such a housing can have a bottom portion that is recessed, and is designed to fit around or over the end of the trunk segment or object in a manner similar to a pipe cap. The inside of the recessed portion (i.e. the recessed cut out) can be cylindrical, cone-shaped, pyramidal, polygonal, and the like. In one example the recessed portion can be cylindrical, and thus can be sized for a particular pipe size, or at least for pipe sizes smaller than the cylinder. In another example, the recessed cutout can have a cone shape, and thus be capable of fitting snuggly or at least substantially snuggly on a variety of pipe sizes. The inside of the cone-shaped recess can be coated with an interface material to improve the coupling between the leveling device and the pipe. Additionally, such an interface material can be coated on the inside of the recess regardless of the shape of the recess.

In another aspect, the housing can be, or can be coupled to, a glove or other device that can be coupled to a human hand. While it should not be seen as limiting, such a device may be beneficial in situations where a user of the device is leveling multiple objects, trees, pipes, or the like. For example, mounting the leveling device to a glove in the location of the top of the hand between or near the area between the thumb and forefinger can facilitate viewing of the leveling device while grasping the object. As such, the leveling device can be mounted on any portion of a glove, sleeve, wristband, ring, or other wearable article that facilitates viewing of the leveling device by the user.

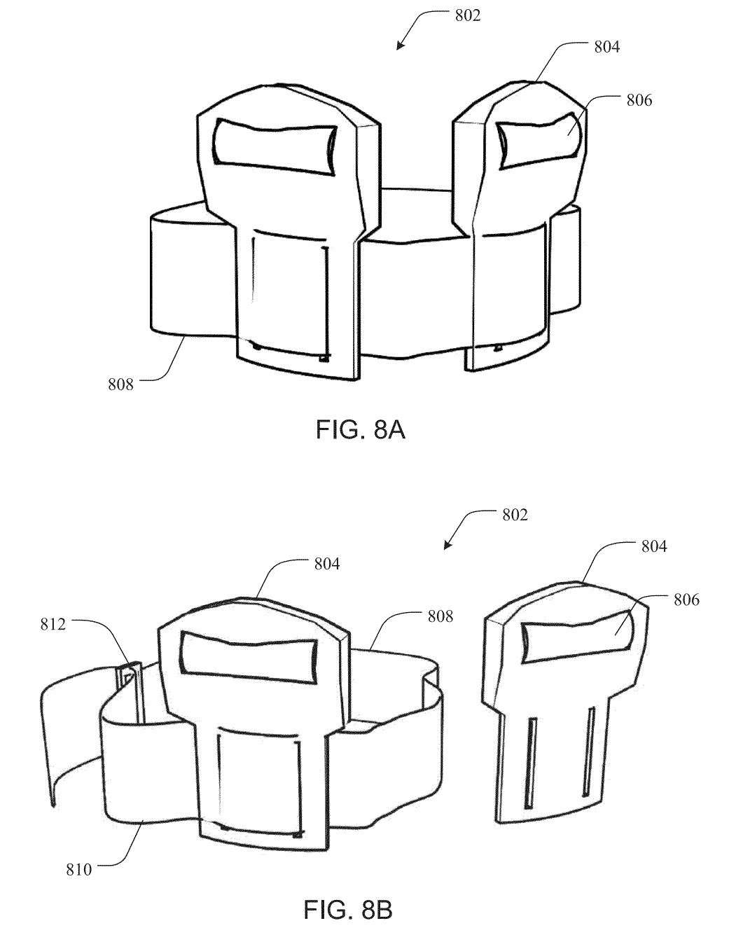

In another aspect, the leveling device can include a housing that fits around, clamps to, or otherwise couples to the outside of the object. As is shown in FIGS. 8A and B for example, the present disclosure additionally provides a leveling device 802 that couples around the outside of an object such as a tree trunk, whether natural or artificial. The device can include one or more level housings 804 having one or more leveling indicators 806 coupled thereto. The leveling indicators 806 can be horizontal levels as shown in FIGS. 8A and B, or any other type of leveling indicator. The device can include a coupling element 808 to couple the level housings 804 to the object to be leveled. The coupling element can be a strap or other flexible material as is shown in FIGS. 8A and B, or the coupling element can be a modification or extension of the level housing itself. For flexible coupling elements, the material can range from elastomeric to non-elastomeric materials depending on the design of the device. For example, in one example the coupling element can be an elastomeric band that stretches during attachment and fits snuggly around the tree trunk or other object as it contracts. Additionally, the flexible coupling element can be continuous or non-continuous. FIG. 8A shows a coupling element that is configured as a continuous band, and can range from elastomeric to non-elastomeric. It is noted, however, that for continuous elements, an elastomeric material can couple more securely to the tree trunk as compared to a non-elastomeric material.

FIG. 8B shows a device having a non-continuous coupling element 810. Such a coupling element 810 can include a securing element 812 to facilitate fastening the coupling element 810 together and/or to the tree. The securing element can include any type of mechanism capable of allowing the leveling device to be secured to the object. Non-limiting examples can include buttons, hooks, buckles, snaps, strings or laces, hook and loop materials (e.g. Velcro®), and the like, including combinations thereof. In some aspects it is additionally contemplated that the ends of the coupling element can be tied together to secure the device to the object. The non-continuous coupling element can be made of any useful material, ranging from elastomeric to non-elastomeric. It is noted that a continuous coupling element that has sufficient slack as compared to the size of the tree trunk can be treated as a non-continuous element as described, and as such is also considered to be within the scope of the term “non-continuous” under these circumstances.

Furthermore, the level housings can be permanently affixed to the coupling element or they can be removably affixed to the coupling element. Depending on the design of the housing, in one aspect the level housings can be removed from the coupling element without undoing or breaking the coupling element. In another aspect, the design of the level housing may require the unfastening of the securing element to remove or replace the level housings, as is shown in FIG. 8B. In the case of the continuous coupling element, the level housing can be configured for removal without breaking the coupling element.

Various materials are contemplated for use as coupling elements, both continuous and non-continuous. Non-limiting examples can include elastomeric polymers, flexible polymers, various cloth materials, synthetic and natural rubber, and the like, including combinations thereof. Additionally, it is contemplated in some aspects that various leveling devices can be permanently coupled to an object such as an artificial tree. In such cases the leveling device can be part of the vertical tubing of the tree, or the leveling device can be a separate device that is intended to be permanently mounted thereto.

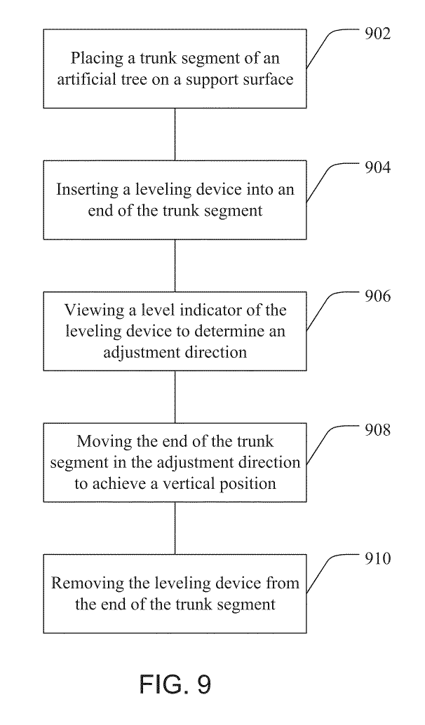

The present disclosure additionally provides methods of positioning an object in a desired position. In one example, as is shown in FIG. 9, a method for positioning an artificial tree in a vertical position can include 902 placing a trunk segment of an artificial tree on a support surface, 904 inserting leveling device into an end of the trunk segment, 906 viewing the level indicator of the leveling device to determine an adjustment direction, 908 moving the end of the trunk segment in the adjustment direction to achieve a vertical position, and 910 removing the leveling device from the end of the trunk segment.

In another example, and following removing the device from the end of the trunk segment, a method can also include inserting a subsequent trunk segment into the end of the vertically aligned trunk segment, inserting the leveling device into an end of the subsequent trunk segment, viewing the level indicator of the leveling device to determine an adjustment direction, moving the end of the subsequent trunk segment in the adjustment direction to achieve a vertical position, and removing the leveling device from the end of the subsequent trunk segment.

In some examples, placing the trunk segment of the artificial tree on the support surface can further include placing a tree stand on the support surface and inserting the trunk segment into a coupling element of the tree stand. In yet another example, the method can further include inserting the leveling device into the coupling element of the tree stand, viewing the level indicator of the leveling device to determine an adjustment direction, moving the coupling element in the adjustment direction to achieve a desired position, and removing the leveling device from the coupling element.

Of course, it is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been described above with particularity and detail in connection with what is presently deemed to be the most practical embodiments of the disclosure, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A leveling device for positioning an artificial tree in a vertical position, comprising:
a housing;
an elongate section extending from the housing and having a structure operable to be inserted into an end of a trunk segment of an artificial tree; and
a level indicator coupled to the housing and positioned to facilitate viewing by a user for leveling the trunk segment in a vertical position.

2. The device of claim 1, wherein the elongate section has a substantially uniform cross section along at least 90% of its length.

3. The device of claim 1, wherein the elongate section has a substantially uniform cross section along at least 25% of its length.

4. The device of claim 1, wherein the elongate section has a non-uniform cross section along at least 90% of its length.

5. The device of claim 1, wherein the elongate section is tapered along at least 90% of its length.

6. The device of claim 1, wherein the elongate section has a cone structure.

7. The device of claim 1, wherein the elongate section includes a plurality of concentric disks coupled together along a central core.

8. The device of claim 7, wherein the plurality of concentric disks is oriented parallel to a leveling plane of the level indicator.

9. The device of claim 1, wherein the elongate section includes incremental markings to facilitate visual alignment of the elongate section in the trunk segment.

10. The device of claim 1, wherein the level indicator is positioned in the housing on a central axis of the elongate section.

11. The device of claim 1, wherein the level indicator is positioned in the housing offset from a central axis of the elongate section.

12. The device of claim 1, wherein the level indicator is a plurality of level indicators.

13. The device of claim 1, wherein the level indicator is a bubble level.

14. A method for positioning an artificial tree in a vertical position, comprising:
placing a trunk segment of an artificial tree on a support surface;
inserting the leveling device of claim 1 into an end of the trunk segment;
viewing the level indicator of the leveling device to determine an adjustment direction;
moving the end of the trunk segment in the adjustment direction to achieve a vertical position; and
removing the leveling device from the end of the trunk segment.

15. The method of claim 14, further comprising:
inserting a subsequent trunk segment into the end of the vertically aligned trunk segment;
inserting the leveling device into an end of the subsequent trunk segment;
viewing the level indicator of the leveling device to determine an adjustment direction;
moving the end of the subsequent trunk segment in the adjustment direction to achieve a vertical position; and
removing the leveling device from the end of the subsequent trunk segment.

16. The method of claim 14, wherein placing the trunk segment of the artificial tree on the support surface further includes:
placing a tree stand on the support surface; and
inserting the trunk segment into a coupling element of the tree stand.

17. The method of claim 16, further comprising:
inserting the leveling device into the coupling element of the tree stand;
viewing the level indicator of the leveling device to determine an adjustment direction;
moving the coupling element in the adjustment direction to achieve a desired position; and
removing the leveling device from the coupling element.
